(19) United States
(12) Patent Application Publication
(10) Pub. No.: US 2018/0196411 A1
(43) Pub. Date: Jul. 12, 2018

(54) METHOD AND DEVICE FOR DETERMINING AN ENERGY-EFFICIENT OPERATING POINT

(71) Applicant: ZF Friedrichshafen AG, Friedrichshafen (DE)

(72) Inventors: Yiwen XU, Tiefenbach (DE); Herman YAKARIA, Langenargen (DE); Tobias KÖSLER, Friedrichshafen (DE); Thomas ACKERMANN, Ravensburg (DE); Johannes BAUER, Bergtheim (DE)

(21) Appl. No.: 15/738,254

(22) PCT Filed: May 23, 2016
(86) PCT No.: PCT/EP2016/061530

§ 371 Date: Dec. 20, 2017

(30) Foreign Application Priority Data
Jun. 26, 2015 (DE) 10 2015 211 944.0

(51) Int. Cl. G05B 19/418; B23Q 15/14; B23Q 5/54; B23Q 17/00; B23Q 41/08; G07C 3/10

(52) U.S. Cl. CPC G05B 19/4187; B23Q 15/14; B23Q 5/54; B23Q 17/00; G05B 2219/39407; G07C 3/10; G05B 2219/25289; G05B 2219/25387; B23Q 41/08

(57) ABSTRACT

A method of determining an energy-efficient operating point of a machine tool of a machine tool system with which identical workpieces for processing can be supplied to the machine tool sequentially in time. The machine tool has an operating point dependent machine cycle time and an operating point dependent power demand. The machine tool system has at least two machine tools and has a system cycle time, and the machine cycle time is shorter than the system cycle time. The method includes determining the energy-efficient operating point in accordance with a machine cycle time dependent characteristic energy demand function of the machine tool. The characteristic energy demand function represents a machine cycle time dependent energy demand of the machine tool over the system cycle time. A corresponding device and a machine tool system are also described.

This application is a National Stage completion of PCT/EP2016/1061530 filed May 23, 2016, which claims priority from German patent application serial no. 10 2015 211 944.0 filed Jun. 26, 2015.

### FIELD OF THE INVENTION

The present invention relates to a method for determining an energy-efficient operating point, a device for determining an energy-efficient operating point and a machine tool system.

### BACKGROUND OF THE INVENTION

In the prior art it is known to equip production machines and production facilities with an energy-saving idle mode, to which they can automatically shift during prolonged periods of inactivity. The availability of the idle mode in an ever-increasing number of production machines and production facilities on the one hand takes environmental protection concepts into account, in particular the reduction of CO₂ emissions. On the other hand, however, the idle mode also contributes toward the avoidance of unnecessary manufacturing costs since production machines and facilites in particular have comparatively high energy demands. This is reflected in not to be underestimated energy costs, which drive up the production costs of a product and thereby reduce its competitiveness.

In this connection DE 11 2009 004 354 T5 discloses a system and a method for reducing an idling power outflow. In this case a machine comprises a number of electronic control devices which are electrically connected to an electric power source on the one hand by way of a first electric circuit by a first relay, and on the other hand by way of a second electric circuit by a second relay. A relay control device is connected to the power source by way of this electric circuit and is at the same time in connection with the first and the second relays. The relay control device is configured in such manner that it opens or closes the first or the second relay in response to a power demand indication. In that way unnecessary power outflow in an idle condition of the machine can be avoided.

DE 10 2004 030 312 A1 discloses an electric tool control device for an electric tool. While the electric tool is operating the control device is acted upon by the full main voltage, whereas in the idle condition it is still supplied, but with a considerably lower voltage. According to DE 10 2004 030 312 A1, in the idle condition the control device receives just as much voltage as will enable it to carry out a standby function. For example, the standby function can consist of the electric supply of a microcontroller or of an electronic circuit for regulating the rotational speed of the electric tool. This reduces the load on the control device and improves efficiency. Thus, the idle condition constitutes an energy-saving mode of the electric tool, in order to keep the current consumption as low as possible when the electric tool is not being used for work.

However, the known devices and methods are beset by disadvantages in that they concentrate exclusively on the energy consumption of a single machine tool without taking into account its incorporation in a system comprising a plurality of machine tools and in particular without taking into account its energetic interaction with the system. Thus, possible energy savings by virtue of a better coordination of the machine tools with one another remain to a large extent ignored.

### SUMMARY OF THE INVENTION

A purpose of the present invention is to propose a better method for determining an energy-efficient operating point of a machine tool of a machine tool system.

According to the invention this objective is achieved by the method for determining an energy-efficient operating point of a machine tool of a machine tool system, according to the independent claim. Advantageous features and further developments of the invention emerge from the dependent claims.

The invention concerns a method for determining an energy-efficient operating point of a machine tool of a machine tool system, such that identical workpieces can be brought to the machine tool sequentially in time for processing, wherein the machine tool has an operating-point-dependent machine cycle time and an operating-point-dependent power demand, wherein the machine tool system comprises at least two machine tools and has a system cycle time, and wherein the machine cycle time is shorter than the system cycle time. The method according to the invention is characterized in that the energy-efficient operating point is determined in accordance with a characteristic energy demand function of the machine tool, such that the characteristic energy demand function represents a machine cycle time dependent energy demand of the machine tool over the system cycle time.

Since the characteristic energy demand function represents the energy demand of the machine tool in a machine cycle time dependent manner, a most energy-efficient operating point possible of the machine tool can be determined comparatively simply with reference to the characteristic energy demand function. For example, the characteristic energy demand function can be determined experimentally by way of a series of tests, or even computationally with reference to known properties of the machine tool. Since therefore the characteristic energy demand function describes the energy demand of the machine tool over the system cycle time, i.e. during the time duration of a system cycle, according to the invention it is not the case that only an isolated optimization of the energy demand of the individual machine tool is carried out during the machine cycle time, but rather, an optimization of the energy demand of the machine tool with regard to its incorporation in the machine tool system as a whole and its interplay with the entire machine tool system.

In the context of the invention the term “operating point” is understood to mean the power uptake of the machine tool as a function of the machine cycle time of the machine tool. In the prior art it is often usual to choose the operating point in such manner that the machine tool is operated close to its maximum power. This then means that the power demand of the machine tool is as a rule comparatively high, whereas in contrast the machine cycle time of the machine tool is as a rule comparatively short. Although a reduction of the operating point of the machine tool leads to a reduction of its power uptake, it also increases the machine cycle time. Thus, since a reduced power uptake prolongs the machine cycle time and hence also prolongs the uptake of operating power over time, a reduction of the operating point does not necessarily translate into a more energy-efficient operating point.

In the context of the invention the term “machine cycle time” is understood to paean the time taken for the machine tool to process a single workpiece. Thus, the machine cycle time denotes the throughput of workpieces by the machine tool per unit of time.

In the context of the invention the term “system cycle time” is understood to mean the time taken for the machine tool system to process a single workpiece. The system cycle time is as a rule markedly determined by the longest machine cycle time among the machine tools that make up the machine tool system. Thus, the system cycle time denotes the throughput of workpieces by the machine tool system per unit of time.

In the context of the invention the term “more energy-efficient operating point” is understood to mean that operating point of the machine tool at which its energy demand is least overall, having regard to its incorporation in the machine tool system as a whole, i.e. in co-operation with other machine tools of the machine tool system, without modifying the operating points of the other machine tools. Thus, the “more energy-efficient operating point” does not necessarily denote the operating point of the machine tool with the highest overall energy efficiency, but only the most energy-efficient operating point overall that can be attained without influencing other machine tools of the machine tool system. Since a machine tool system usually comprises a plurality of machine tools whose interaction has been finely coordinated by a lengthy procedure in order to enable a production process as robust and free from complications as possible, the method according to the invention is preferably limited to the framework.

In the context of the invention the term “machine tool” is understood to mean any type of machine capable of processing a workpiece. For example, the machine tool can be designed to cast, file, mill, drill, lacquer or heat the workpiece.

According to a preferred embodiment of the invention it is provided that the characteristic energy demand function is determined with the aid of a machine cycle time dependent power demand characteristic. As already described, a change of the operating point of the machine tool leads, on the one hand, to a change of the power demand of the machine tool during the machine cycle time and, on the other hand, to a change of the machine cycle time. After the end of the working process, i.e. after the lapse of the machine cycle time, the machine tool is usually in an idle mode which lasts until the end of the system cycle time, i.e. the time difference between the system cycle time and the machine cycle time persists. In this idle mode the machine tool has a largely constant and in particular machine cycle time independent power demand. Thus, the use of the machine cycle time dependent power demand characteristic as the basis for determining the characteristic energy demand leads to a reliable characteristic energy demand function, since the characteristic energy demand function of the machine tool describes the energy demand of the machine tool with regard to its incorporation in the machine tool system.

Since the machine cycle time dependent power demand of the machine tool is integrated over the machine cycle time, the energy demand of the machine tool is obtained over the machine cycle time. This energy demand during the machine cycle time is the main part of the total energy demand of the machine tool during the system cycle time. Inasmuch as the machine cycle time dependent power demand of the machine tool is integrated over the system cycle time, the complete energy demand of the machine tool over the system cycle time is obtained.

Preferably, it is provided that the power demand characteristic is a straight line, which is determined by determining various operating points and fitting the line to the various operating points. In this way the power demand characteristic is determined experimentally. That always results in obtaining a reliable and realistic power demand characteristic.

Since with increasing power or a higher operating point the machine cycle time is reduced, the line representing the power demand characteristic has a negative sign.

In the context of the invention the term “fitting the line” is understood to mean that the power demand characteristic, or line, is adjusted to the best possible fit through the various operating points or through the machine cycle times and power demands represented by the various operating points.

In a particularly preferred embodiment of the invention it is provided that the characteristic energy demand function is a parabola, the parabola being determined by the equation

ΣΕ(t_{MTZ})=(m⊗t_{MTZ}+b)⊗t_{MTZ}+P_{Ruhe},

wherein ΣΕ(t_{MTZ}) is a machine cycle time dependent energy demand of the machine tool over the system cycle time, wherein the factor (m⊗t_{MTZ}+b) is the machine cycle time dependent power demand characteristic, wherein t_{MTZ} is the machine cycle time, wherein t_{Ruhe} is an idle time of the machine tool after the end of the machine cycle time until the end of the system cycle time, and wherein P_{Ruhe} is a power demand of the machine tool during the idle time. Thus, the characteristic energy demand function describes the machine cycle time dependent energy demand of the machine tool during the system cycle time in the form of a parabola open downward. Namely, it has been shown that a characteristic energy demand function determined in such a manner is reliably appropriate for determining the energy-efficient operating point of the machine tool.

Preferably, it is provided that the idle time is the sum of all those times in which the machine tool is not in a working mode. For example, the idle time can include the time in a so-termed basic mode, a so-termed secondary mode and a so-termed standby mode, each of the modes having an individual power demand of the machine tool. Usually, with increasing idle time the machine tool shuts down more and more machine tool components in order to enable further energy savings, and thus approaches step by step the standby mode which as a rule has the lowest power demand. For example, if the machine tool is a grinding machine for grinding the teeth of gearwheels, immediately on entry into the idle time the machine can switch to the secondary mode. In the secondary mode, first of all exclusively the drives of the spindle which hold the gearwheel to be ground and move according to the requirements of the grinding process, are switched off. As the idle time continues the machine tool can then change to the basic mode. In the basic mode the main spindle is deactivated and in addition the pneumatic and hydraulic components of the machine tool are switched off. Finally, if the idle time lasts even longer, cooling systems and electronic control systems of the machine tool can also be switched off. Thus, during the idle time the power demand of the machine tool is reduced more and more, in steps.

According to a further, particularly preferred embodiment of the invention, it is provided that an intersection point of the parabola with the system cycle time is determined and an imaginary horizontal line is drawn through the intersection point. This has been found to be a particularly suitable intermediate step on the way toward the reliable determination of the energy-efficient operating point of the machine tool.

According to a still further, particularly preferred embodiment of the invention, it is provided that the operating point of the machine tool is moved to the intersection point if the machine cycle time dependent energy demand of the machine tool is above the horizontal. Thus, this corresponds to a reduction of the operating point. Namely, it has been shown that in such a case, by reducing the operating point to the intersection point a reduction of the energy demand of the machine tool is possible, even though the machine cycle time, i.e. the time during which the machine tool is in the working mode and has a comparatively high power demand, is thereby made longer.

In a further, particularly preferred embodiment of the invention, it is provided that the energy-efficient operating point is determined while retaining the same system cycle time. In that way the method according to the invention advantageously does not result in an extension of the system cycle time and thus also does not slow down the production of workpieces. Rather, the system cycle time and therefore the throughput of workpieces by the machine tool system per unit of time is maintained.

According to a further preferred embodiment of the invention it is provided that the energy-efficient operating point is determined with regard to an electrical energy demand of the machine tool. Since the electrical energy demand usually accounts for the main part of the total energy demand of present-day machine tools, the invention advantageously concentrates on this. Furthermore the electrical energy demand is comparatively simple to measure and control. In particular, the energy-efficient operating point of the machine tool is not related to an energy demand based on gas, oil or coal.

In a further preferred embodiment of the invention it is provided that the method is repeated for every machine tool whose cycle time is shorter than the system cycle time. This has the advantage that for each individual machine tool of the machine tool system a more energy-efficient operating point is determined. Furthermore, the actual operating point of each machine tool can then be adapted to the more energy-efficient operating point determined. Since for each machine tool of the machine tool system whose machine cycle time is shorter than the system cycle time, in each case a more energy-efficient operating point that takes into account the incorporation of the machine tool in the machine tool system is determined, a more energy-efficient operating point for the machine tool system as a whole is obtained. Thus the method according to the invention makes it possible to save energy not just at an individual machine tool, but rather in the entire machine tool system which can comprise a plurality of machine tools.

Preferably, it is provided that the machine tool system is designed to process the workpieces by cutting methods. Since the processing of workpieces by cutting is particularly energy-intensive, in such a case a large savings of energy can be achieved by virtue of the method according to the invention.

Particularly preferably, it is provided that all of the at least two machine tools are designed to process the workpieces by cutting methods. Alternatively, however, it is possible and preferable for only one, or some of the machine tools to be designed to process the workpieces by cutting.

According to another particularly preferred embodiment of the invention it is provided that the machine tool system is designed to process the workpieces by grinding and/or milling and/or turning. In relation to possible energy savings, the method according to the invention has been found to be particularly advantageous in a machine tool system of that type.

A grinding process or a milling process or a turning process usually includes a rough-machining stage followed by a finish-machining stage. In such a case the rough-machining process serves to remove material from the workpiece with a comparatively large chip volume. The rough-machining process is intended to bring the workpiece to approximately its final contour within as short a machining time as possible. Accordingly, rough-machining tool usually have comparatively coarse-toothed tools with a larger depth of cut. As a rule the rough-machining process leaves a comparatively rough surface and not very great dimensional accuracy. The exact and desired end contour of a workpiece, in contrast, is produced in the subsequent finish-machining process. Accordingly, finishing tools usually have substantially finer teeth and operate with a comparatively smaller cutting depth, so that a comparatively smoother surface is produced.

In a further, particularly preferred embodiment of the invention it is provided that the machine tool system is designed to grind and/or mill gearwheel teeth. Since it is exactly the grinding or milling of gearwheel teeth which are particularly energy-intensive processes, in such cases the method according to the invention provides substantial energy-saving possibilities.

According to a further, again particularly preferred embodiment of the invention, it is provided that the operating point is determined by a rough-machining time and a rough-machining power. Thus, the invention preferably concentrates on the rough-machining process, since on the one hand this is the more energy-intensive stage and on the other hand it can be modified without regard to the surface roughness produced on the workpiece, since the surface roughness and contour accuracy are produced as desired in the subsequent finish-machining process.

In particular, the operating point is not determined by a finishing time and a finishing power. A change of the finishing time and finishing power would have direct effects on the quality of the workpiece produced. However, workpiece quality demands are as a rule fixed. Thus, although a change of finishing time and finishing power could result in an energy saving, this would as a rule have undesired effects on the workpiece quality.

The invention also concerns a device for determining an energy-efficient operating point of a machine tool in a machine tool system, wherein identical workpieces can be supplied successively in time to the machine tool for processing, wherein the machine tool system comprises at least two machine tools and has a system cycle time, such that the device is designed to detect by time determination means an operating point dependent machine cycle time and by power determination means an operating point dependent power demand of the machine tool, wherein the machine cycle time is shorter than the system cycle time. The device according to the invention is characterized in that it is designed to determine by determination means the energy-efficient operating point in accordance with a characteristic energy demand function of the machine tool, such that the characteristic energy demand function represents a machine cycle time dependent energy demand of the machine tool over the system cycle time. Thus, since the device according to the invention comprises all the means required for carrying out the method according to the invention, it makes possible the advantages already described in connection with the method according to the invention.

The time determination means can for example be a crystal oscillator based clock whose dock signals are emitted at specified time intervals and are counted by a counter and summed. For its part the counter can be an electronic counter, for example integrated in an electronic computer device, in particular a microcontroller.

The power determination means can for example be known voltage determination means and known current determination means. Both the voltage determination means and the current determination means can for example determine the voltage or current, respectively, within a specified time interval, and from the current and voltage determined, can compute the power taken up by the machine tool. For computing the power, the power determination means can for example also comprise an electronic computer unit that multiplies the current determined with the voltage determined and then standardizes the value so determined to one second in order to derive the power take-up of the machine tool.

The determination means can for example also be in the form of an electronic computer unit, in particular a microcontroller. Preferably, on the data level electronic storage means are linked with the electronic computer unit, which can have reading and writing access to the electronic computer unit.

Particularly preferably, the determination means are also designed to read out the time determination means and the power determination means.

To determine the energy-efficient operating point of the machine tool, the determination means can for example carry out a software algorithm designed for the purpose, such that the software algorithm instructs the determination means or the device to implement the method according to the invention. The software algorithm is preferably stored in the electronic storage means.

In a preferred embodiment of the invention it is provided that the device is structurally and functionally integrated in the machine tool system. This has the advantage that in relation to the necessary means and hardware resources for carrying out the method according to the invention, the machine tool system can have recourse to hardware which is in any case present in it. This reduces the cost and effort for implementing the device according to the invention in a machine tool system. Alternatively, however, the device according to the invention can be structurally and functionally separate from a machine tool system. In the latter case, the connections required for carrying out the method according to the invention can for example be formed by a wired data link.

Particularly preferably, the device is structurally and functionally integrated in one of the machine tools of the machine tool system. Since many machine tools in any case comprise a complex and powerful electronic system for control and regulation, the device can also be structurally and functionally integrated in such a machine tool.

In the context of the invention the term “structurally integrated” is understood to mean that the device, with the necessary means, is structurally integrated in a control unit of one of the machine tools of the machine tool system or directly in a control unit of the machine tool system.

In the context of the invention the term “functionally integrated” is understood to mean that the device has access to hardware in any case present in the machine tool system or one of its machine tools, in order to use it for carrying out the method according to the invention.

According to a further preferred embodiment of the invention, it is provided that the device is designed to carry out the method according to the invention. From this stem the advantages already mentioned.

Finally, the invention also concerns a machine tool system comprising a device according to the invention. The advantages mentioned in connection with the device according to the invention are thereby obtained in relation to the machine tool system according to the invention.

### BRIEF DESCRIPTION OF THE DRAWINGS

Below, examples of the invention are explained with reference to the embodiments illustrated in the figures, which show:

FIG. 1: Schematic representation of a possible form of a machine tool system according to the invention, as an example,

FIG. 2: Schematic representation of another possible form of a machine tool system according to the invention, as an example,

FIG. 3: An example of a machine cycle time dependent power demand characteristic,

FIG. 4: An example of a machine cycle time dependent characteristic energy demand function,

FIG. 5: An example showing the energy demand of a machine tool over a system cycle time, and

FIG. 6: An example embodiment of a method according to the invention, in the form of a flow chart.

### DETAILED DESCRIPTION OF THE PREFERRED EMBODIMENTS

In all the figures the same objects, functional units and comparable components are denoted by the same indexes. In relation to their technical features these objects, functional units and comparable components are of identical design unless otherwise indicated explicitly or implicitly in the description.

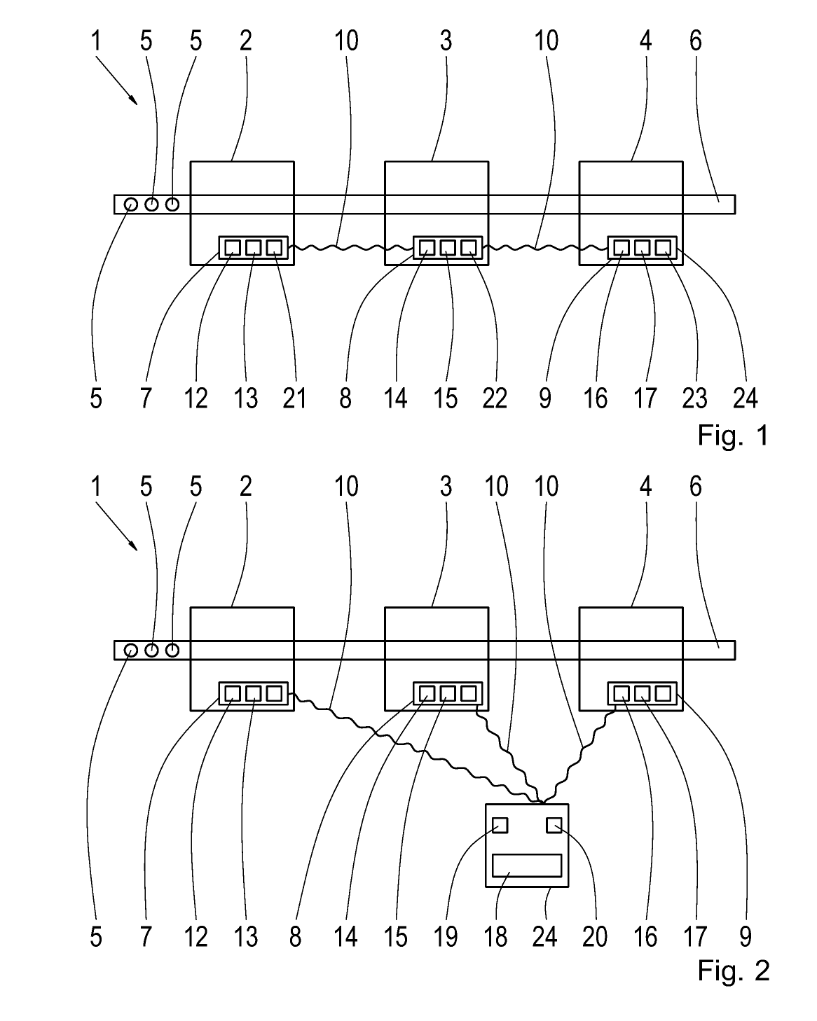

FIG. 1 schematically shows, as an example, a possible embodiment of a machine tool system 1 according to the invention. The machine tool system 1 shown as an example comprises three machine tools 2, 3 and 4. For its part, the machine tool 2 has a control unit 7. In turn, in this example the control unit 7 comprises time determination means 12, power determination means 13 and an electronic computer unit 21. The machine tool 3 has a control unit 8 which, for its part, comprises time determination means 14, power determination means 15 and an electronic computer unit 22. Finally, the machine tool 4 has a control unit 9. For its part, the control unit 9 comprises time determination means 16, power determination means 17 and an electronic computer unit 23. In this example a device 24 according to the invention for determining an energy-efficient operating point of a machine tool of a machine tool system is structurally and functionally integrated in the control unit 9. In this case the control unit 9 and the device 24 are identical. Correspondingly, the electronic computer unit 23 serves not only to control and regulate the machine tool 4, but in addition serves as a determination means 23 of the device 24. Furthermore, storage means on the data level (not shown) are linked to the electronic computer unit 23. Likewise, the time determination means 16 and the power determination means 17 of the control unit 9 serve as the time determination means 16 and the power determination means 17 of the device 24. By way of data connections 10 the control unit 24 or the device 24 is connected to the control unit 8 and the control unit 7. By way of the data connections 10, the control unit 9 can read out the time determination means 14 and the power determination means 15 of the control unit 8 and the time determination means 12 and power determination means 13 of the control unit 7. The machine tool system 1 shown as an example also comprises a conveyor belt 6 on which workpieces 5 are arranged. The workpieces 5 are the same, i.e. identical workpieces 5, which in this example are in the form of metallic cylinders. In time the workpieces 5 are supplied sequentially to the machine tool 2, the machine tool 3 and the machine tool 4. The machine tool 2 has a machine cycle time of, for example, 20 s. This means that the machine tool 2 needs 20 s to process a workpiece 5. For example, the machine tool 2 performs a milling operation on the workpiece 5 and is operated at maximum power. This means that it is operated at the highest possible operating point 31, 44, 45 and 46. Once the machine tool 2 has finished machining the workpiece 5, the workpiece 5 is conveyed by the conveyor belt 6 to the machine tool 3. The machine tool 3 has for example a machine cycle time of 16 s, which means that the time taken by the machine tool 3 to process a workpiece is 16 s. The machine tool 3 too is operated at maximum power, which corresponds to the highest possible operating point 31, 45, 46. For example, the machine tool 3 is a grinding machine which performs a rough-grinding and a finish-grinding operation on the workpieces 5. The machine tool 4 has for example a machine cycle time of 18 s, meaning that it needs 18 s to process a workpiece 5. In this example the machine tool 4 tool is operated at maximum power, i.e. at the highest possible operating point 44. As an example, the machine tool 4 is a furnace which heat treats the workpieces 5. Since the system cycle time t₁, i.e. the total processing duration for a workpiece 5 by the machine tool system 1, is characterized by the longest machine cycle time or corresponds to it, the system cycle time t₁ in this example amounts to 20 s. Since the control unit 9 comprises the time determination means 16, the power determination means 17 and the determination means 18, as already described it corresponds to the device 24 according to the invention. In this example it also carries out the method according to the invention. During the course of carrying out the method according to the invention, the control unit 9 or the device 24 first varies the operating point 31, 44, 45, 46 of the machine tool 3. Owing to the change of its operating point 31, 44, 45, 46 the power demand of the machine tool 3 and its machine cycle time also change. The operating point 31, 44, 45, 46 is in each case defined by the power demand of the machine tool 3 for a given machine cycle time of the machine tool 3. Thus, the device 24 detects the various operating points 31, 44, 45, 46 of the machine tool 3 and by computation fits a straight line 30 through the various operating points 31, 44, 45, 46, This line 30 represents a machine cycle time dependent power demand characteristic 30. By virtue of the power demand characteristic 30 determined in that way, the device 24 now determines a machine cycle time dependent characteristic energy demand function 40, which is in the form of a parabola. The machine cycle time dependent characteristic energy demand function 40 represents the energy demand of the machine tool 3 as a function of the machine cycle time of the machine tool 3. Furthermore, the device 9 determines a point of intersection 42 on the parabola 40 with the system cycle time t₁. A comparison of the position of the highest possible operating point 31, 45, 46 of the machine tool 3 selected as standard, which is on the parabola 40, with the position of the horizontal line 48, shows for example that the operating point 31, 45, 46 of the machine tool 3 is above the horizontal 48. Accordingly the device 9 adapts the operating point 31, 45, 46 of the machine tool 3 in such manner that it now coincides with the point of intersection 42. Correspondingly, the machine cycle time of the machine tool 3 changes to 20 s. This leads to an energy saving in the machine tool 3. Furthermore, the control unit 9 or device 24 carries out the method according to the invention in an identical manner once more for the machine tool 4. In this case it emerges that a maximum operating point 44 of the machine tool 4 selected as standard is below the horizontal 48 on the parabola. This means that an energy saving in the machine tool 4 is not possible by changing the machine cycle time or changing the operating point 44 of the machine tool 4 without extending the system cycle time t₁. Accordingly, the machine cycle time and the operating point 44 of the machine tool 4 are retained. There is no need to carry out the method according to the invention yet again for the machine tool 2, since the system cycle time t₁ is determined by the machine cycle time of the machine tool 2 or is equal to it. A reduction of the operating point 31, 44, 45, 46 of the machine tool 2 would result in increasing the machine cycle time of the machine tool 2 and would thus also increase the system cycle time t₁. However, since in this example the system cycle time t₁ is kept the same in order not to slow down the production or processing of the workpieces 5, no change is made to the operating point 31, 44, 45, 46, as described. Thus, the machine tools 2, 3 and 4 each operate at an energy-efficient operating point 31, 44, 45, 46 while maintaining the system cycle time t₁ of 20 s, Consequently, the machine tool system 1 also operates at an energy-efficient operating point.

According to a further example embodiment of a device 24 according to the invention depicted schematically in FIG. 2, the device 24 is structurally independent of the machine tools 2, 3 and 4, In this case the device 24 is connected by means of suitable data connections 10 to the control units 7, 8 and 9 of the machine tools 2, 3 and 4. Although in this example the device 24 is structurally independent of the machine tools 2, 3 and 4, it is partially functionally integrated with them inasmuch as it has access to the time determination means 12, 14 and 16 in the machine tools 2, 3 and 4, respectively, and to the power determination means 13, 15 and 17 in the machine tools 2, 3 and 4, for the purpose of implementing the method according to the invention.

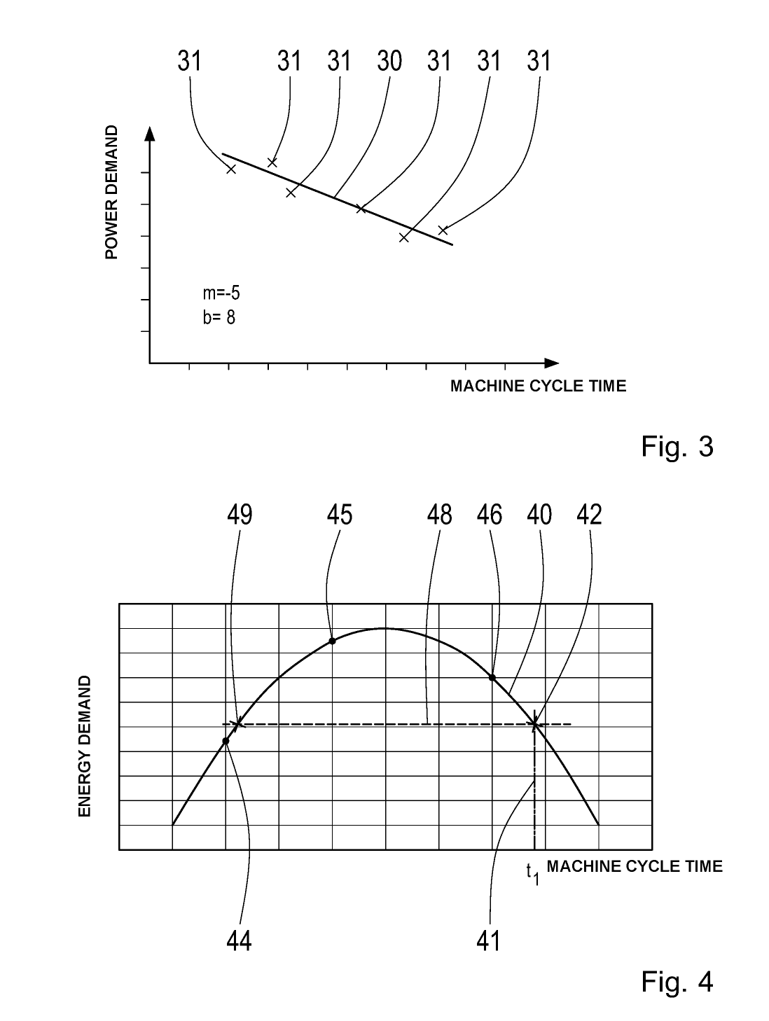

FIG. 3 shows as an example, and schematically, a machine cycle time dependent power demand characteristic 30 in the form of a straight line 30. The power demand characteristic 30 has been determined in that previously, different operating point 31 of a machine tool 2, 3 or 4 were determined. The power demand characteristic 30 is now plotted on a co-ordinate system having the machine cycle time along its x-axis and the power demand along its y-axis. The power demand characteristic 30 has been determined by adapting, i.e. fitting the line 30 through the various operating points 31. As can be seen, the line 30 slopes downward with increasing machine cycle time, which means that as the machine cycle time increases the power demand during the machine cycle time decreases. Since the line 30 slopes downward with increasing machine cycle time, the gradient of the associated line equation has a negative sign. From the power demand characteristic 30 determined in this way by fitting to the various operating points 31, the known line equation of the form y=b can now be determined by computation. In this example the computed determination of the line equation gives a value of −5 for the gradient m of the power demand characteristic 30, and a value of 8 for the axis intercept b of the power demand characteristic 30. The line equation so defined can now be used to determine the machine cycle time dependent characteristic energy demand function 40.

FIG. 4 shows as an example a machine cycle time dependent characteristic energy demand function 40 of a machine tool 2, 3 or 4. The characteristic energy demand function 40 describes the energy demand of the machine tool 2, 3 or 4 over the system cycle time t₁, and in this example is in the form of a parabola 40 open downward. This form of the characteristic energy demand function 40 is derived from the basic equation:

ΣΕ(t_{MTZ})=(m⊗t_{MTZ}+b)⊗t_{MTZ+}P_{Warten}⊗t_{Warten},

which is a polynomial of the second order. Owing to the negative gradient of the power demand characteristic 30, the factor m has a negative sign whose result is that the parabola 40 is open downward. The characteristic energy demand function 40 shows clearly that the energy demand of the machine tool 2, 3 or 4 is highest when the power demand and the machine cycle time have medium values, while in contrast, when the power demand is lower and the machine cycle time correspondingly longer, and conversely when the power demand is high and the machine cycle time is correspondingly shorter, energy can be saved. The characteristic energy demand function 40 shown as an example is plotted in a co-ordinate system whose x-axis shows the machine cycle time and whose y-axis shows the energy demand of the machine tool 2, 3 or 4 during the system cycle time t₁. The time-point t₁ is the system cycle time t₁. Starting from t₁, a vertical dot-dash line 41 is drawn upward. The dot-dash line 41 intersects the parabola 40 at an intersection point 42. Starting from the intersection point 42, an imaginary horizontal line 48 is now drawn. The course of the parabola 40 describes for example various operating points 44, 45, 46 of an associated machine tool 2, 3 or 4. In the case of the operating point 44 the machine cycle time is comparatively short. However, since the operating point 44 is below the horizontal line 48, no energy saving is made possible by changing the operating point 44. In the case of the operating point 45, however, an energy saving is made possible by changing the operating point 45 since the operating point 45 is above the horizontal line 48. Thus for example, the operating point 45 is lowered until it coincides with the intersection point 42. This increases the machine cycle time so that it corresponds to the system cycle time t₁ and at the same time leads to a saving of energy. Likewise, it would also be possible to increase the operating point 45 so that it moves to an area of the parabola 40 under a further intersection point 49. That would also result in an energy saving in the machine tool 2, 3 or 4 without influencing the system cycle time t₁ or producing other effects on the machine tool system 1. However, this is only possible when the machine tool 2, 3 or 4, which is working at operating point 45, possesses corresponding power reserves, which is not the case in this example. Likewise, in the case of the operating point 46 an energy saving is possible since the operating point 46 too is above the horizontal line 48. In that the operating point 46 is displaced to the intersection point 42, in this case as well the machine cycle time is increased so that it corresponds to the system cycle time t₁. This too results in a saving of energy, Alternatively, to achieve an energy saving the operating point 46 is also moved to the area of the parabola 40 under the further intersection point 49. In this case, however, in the example considered the power reserves of the machine tools 2, 3 or 4 are not sufficient for such an increase of the operating point 46.

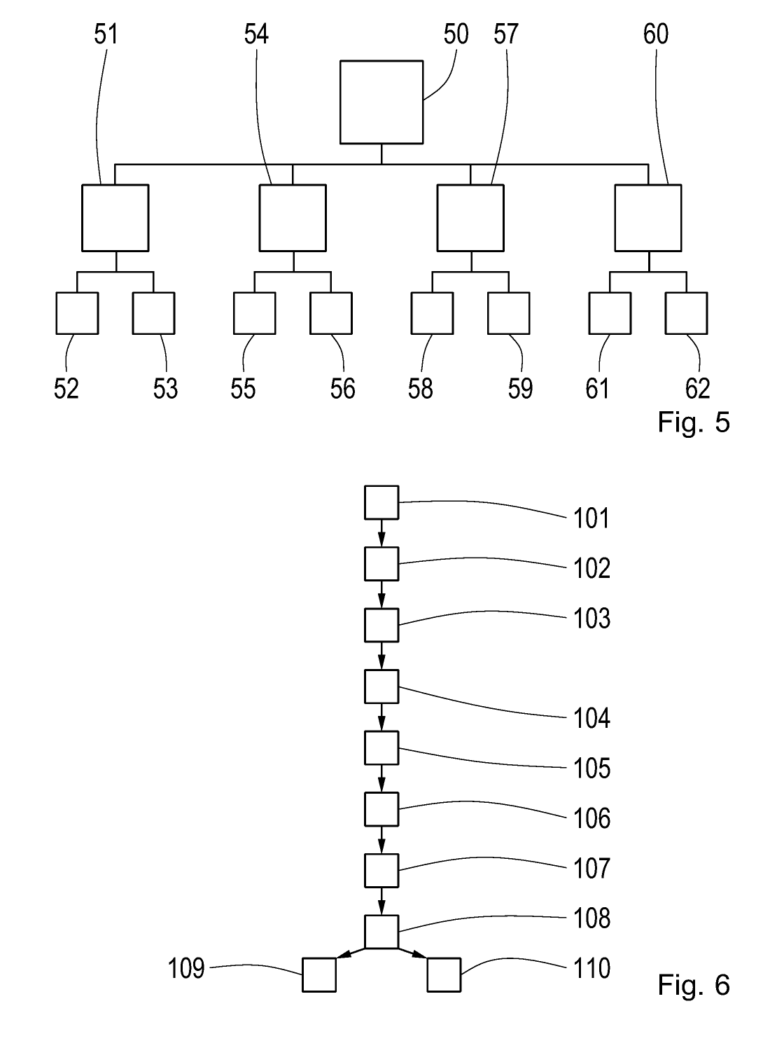

FIG. 5 shows as an example an energy demand 50 of a machine tool 2, 3 or 4 during a system cycle time t₁. As can be seen, the energy demand consists of the powers 52, 55, 58, 61 required in the various operating modes of a machine tool 2, 3 or 4 and the times 53, 56, 59, 62 spent in the various operating modes. In this example the total energy 50 consists of a partial energy 51 in the processing mode, the partial energy 51 consisting of a power 52 required in the processing mode and the machine cycle time 53. In addition the total energy 50 comprises a partial energy 54 which the machine tool 2, 3 or 4 requires in the secondary mode. The partial energy 54 consists of a power 55 required in the secondary mode and a time 56 spent in the secondary mode. Furthermore the total energy 50 comprises a partial energy 57, which the machine 2, 3 or 4 requires in the idling mode. This partial energy, in turn, consists of the power 58 required in the idling mode and the time 59 spent by the machine tool in the idling mode. Finally, the total energy 50 also comprises the partial energy 60 required by the machine tool 2, 3 or 4 in the standby mode. The partial energy 60 in turn consists of the power 61 required in the standby mode and the time 62 spent by the machine tool in the standby mode.

FIG. 6 shows as an example an embodiment of a method according to the invention, in the form of a flow chart. In process step 101, identical workpieces 5 are first supplied in a time sequence to a machine tool 2, 3 or 4 of a machine tool system 1 for processing. The machine tool 2, 3 or 4 has an operating point dependent machine cycle time and an operating point dependent power demand. In the next process step 102 the operating point 31, 44, 45 or 46 of the machine tool 2, 3 or 4 is varied, so that in process step 103 the respective machine cycle time and the power demand of the machine tool 2, 3 or 4 at the various operating points 31, 44, 45, 46 can be determined. In the next process step 104 a straight line 30 is now fitted through the various operating points 31 44, 45, 46 determined. This line 30 represents the power demand characteristic. In step 105 the power demand characteristic 30 is used to determine the characteristic energy demand function 40 of the machine tool 2, 3 or 4. In this example the characteristic energy demand function 40 is a parabola 40. In the now following step 106 a point of intersection 42 of the parabola 40 with the system cycle time t₁ is determined. In step 107 an imaginary horizontal line 48 is drawn through the intersection point 42. With reference to the current machine cycle time the actual operating point 31, 44, 45 or 46 of the machine tool 2, 3 or 4 on the parabola 40 is determined in step 108. If the actual operating point 31, 44, 45 or 46 of the machine tool 2, 3 or 4 is below the horizontal 48, in step 109 no savings of energy is possible. The machine tool 2, 3 or 4 is already at an energy-efficient operating point 31, 44, 45 or 46 while the current system cycle time t₁ is maintained. But if the current operating point 31, 44, 45 or 46 is above the horizontal 48 on the parabola 40, then in process step 110 a savings of energy is possible by moving the operating point 31, 44, 45 or 46 to the intersection point 42. This results on the one hand in an increase of the machine cycle time so that it corresponds to the system cycle time t₁, and on the other hand to a savings of energy. The machine tool 2, 3 or 4 is thereby at an energy-efficient operating point 31, 44, 45 or 46.

### Indexes

1 Machine tool system

2 Machine tool

3 Machine tool

4 Machine tool

5 Workpiece

6 Conveyor belt

7 Control unit of machine tool 2

8 Control unit of machine tool 3

9 Control unit of machine tool 4

10 Data connection

11 Data connection

12 Time determination means of the control unit 7

13 Power determination means of the control unit 7

14 Time determination means of the control unit 8

15 Power determination means of the control unit 8

16 Time determination means of the control unit 9

17 Power determination means of the control unit 9

18 Determination means

21 Electronic computer unit

22 Electronic computer unit

23 Electronic computer unit

24 Device

30 Power demand characteristic

31 Operating point

40 Characteristic energy demand function

41 Line representing the system cycle time

42 Intersection point

44 Operating point

45 Operating point

46 Operating point

48 Horizontal line

49 Further intersection point

50 Total energy demand over the system cycle time

51 Partial energy demand over the machine cycle time

52 Power demand over the machine cycle time

53 Machine cycle time

54 Partial energy demand during the secondary mode time

55 Power demand during the secondary mode time

56 Secondary mode time

57 Partial energy demand during the idling mode time

58 Power demand during the idling mode time

59 idling mode time

60 Partial energy demand during the standby mode time

61 Power demand during the standby mode time

62 Standby mode time

101 Workpieces supplied

102 Operating point changed

103 Determination of the machine cycle time and the power demand

104 Fitting of the power demand characteristic

105 Determination of the characteristic energy demand function

106 Determination of the first point

107 Drawing of a horizontal line through the first point

108 Determination of the actual operating point

109 Energy saving not possible

110 Operating point changed

t₁ System cycle time

1-15. (canceled)

16. A method of determining an energy-efficient operating point (31, 44, 45, 46) of a machine tool (2, 3, 4) of a machine tool system (1) in which identical workpieces (5) for processing are supplied to the machine tool (2, 3, 4) sequentially in time, the machine tool (2, 3, 4) having an operating point dependent machine cycle time and an operating point dependent power demand, the machine tool system having at least two machine tools (2, 3, 4) and having a system cycle time (t₁), and the machine cycle time is shorter than the system cycle time (t₁), the method comprising:
determining the energy-efficient operating point (31, 44, 45, 46) in accordance with a machine cycle time dependent characteristic energy demand function of the machine tool (2, 3, 4), and the characteristic energy demand function representing a machine cycle time dependent energy demand of the machine tool (2, 3, 4) over the system cycle time (t₁).

17. The method according to claim 16, further comprising determining the characteristic energy demand function using a machine cycle time dependent power demand characteristic (30).

18. The method according to claim 17, further comprising defining the characteristic energy demand function (30) as a parabola (40), and the parabola (40) being determined by an equation:)
ΣΕ(t_{MTZ})=m⊗t_{MTZ}+b)⊗t_{MTZ}P_{Warten}t_{Warten}
wherein ΣΕ(t_{MTZ}) is a machine cycle time dependent energy demand of the machine tool (2, 3, 4) over the system cycle time (t₁),
factor (m⊗t_{MTZ}+b) is the machine cycle time dependent power demand characteristic (30),
factor t_{MTZ} is the machine cycle time,
factor t_{Warten} is a waiting time of the machine tool (2, 3, 4) after an end of the machine cycle time until an end of the system cycle time (t1), and
factor P_{Warten} is a power demand of the machine tool (2, 3, 4) during the waiting time.

19. The method according to claim 18, further comprising determining a point of intersection (42) of the parabola (40) with the system cycle time (t₁), and drawing an imaginary horizontal line (48) through the intersection point (42).

20. The method according to claim 19, further comprising moving the operating point (31, 44, 45, 46) of the machine tool (2, 3, 4) to the intersection point (42) if the machine cycle time dependent energy demand of the machine tool (2, 3, 4) is above the horizontal line (48).

21. The method according to claim 16, further comprising determining a most energy-efficient operating point (31, 44, 45, 46) while retaining the system cycle time (t₁).

22. The method according to claim 16, further comprising determining a most energy-efficient operating point (31, 44, 45, 46) with regard to an electrical energy demand of the machine tool (2, 3, 4).

23. The method according to claim 16, further comprising repeating the method for every machine tool (2, 3, 4) having a machine cycle time shorter than the system cycle time (t₁).

24. The method according to claim 16, further comprising designing the machine tool system (1) to process the workpieces (5) by at least one of grinding, milling and turning.

25. The method according to claim 24, further comprising designing the machine tool system (1) to at least one of grind and mill gearwheel teeth.

26. The method according to claim 24, further comprising determining the operating point (31, 44, 45, 46) by a rough-machining time and a rough-machining power.

27. A device (9, 24) for determining an energy-efficient operating point (31, 44, 45, 46) of a machine tool (2, 3, 4) of a machine tool system (1) with which identical workpieces (5) are supplied to the machine tool (2, 3, 4) sequentially in time for processing, the machine tool system (1) having at least two machine tools (2, 3, 4) and having a system cycle time (t₁), the device (9, 24) comprising:
a time determination means (12, 14, 16) for determining an operating point dependent machine cycle time, and a power determination means (13, 15, 17) for determining an operating point dependent power demand of the machine tool (2, 3, 4), and the machine cycle time being shorter than the system cycle time (t₁),
energy determination means (18, 21, 22, 23) for determining the energy-efficient operating point (31, 44, 45, 46) in accordance with a machine cycle time dependent characteristic energy demand function (40) of the machine tool (2, 3, 4), and the characteristic energy demand function (40) represents a machine cycle time dependent energy demand of the machine tool (2, 3, 4) over the system cycle time (t₁).

28. The device (9, 24) according to claim 27, wherein the device (9, 24) is structurally and functionally integrated in the machine tool system (1).

29. The device (9, 24) according to claim 27, wherein the device is designed to carry out a method for determining the energy-efficient operating point (31, 44, 45, 46) of the machine tool (2, 3, 4) of the machine tool system (1) including determining the energy-efficient operating point (31, 44, 45, 46) in accordance with the machine cycle time dependent characteristic energy demand function of the machine tool (2, 3, 4), and the characteristic energy demand function representing the machine cycle time dependent energy demand of the machine tool (2, 3, 4) over the system cycle time (t₁).

30. A machine tool system (1) comprising a device (9, 24) for determining an energy-efficient operating point (31, 44, 45, 46) of a machine tool (2, 3, 4) of a machine tool system (1) with which identical workpieces (5) can be supplied to the machine tool (2, 3, 4) sequentially in time for processing, the machine tool system (1) having at least two machine tools (2, 3, 4) and having a system cycle time (t₁), the device (9, 24) comprising a time determination means (12, 14, 16) for determining an operating point dependent machine cycle time, and a power determination means (13, 15, 17) for determining an operating point dependent power demand of the machine tool (2, 3, 4), and the machine cycle time being shorter than the system cycle time (t₁), and the device (9, 24) having energy determination means (18, 21, 22, 23) for determining the energy-efficient operating point (31, 44, 45, 46) in accordance with a machine cycle time dependent characteristic energy demand function (40) of the machine tool (2, 3, 4), and the characteristic energy demand function (40) represents a machine cycle time dependent energy demand of the machine tool (2, 3, 4) over the system cycle time (t₁).
